(19) United States
(12) Patent Application Publication
(10) Pub. No.: US 2024/0337778 A1
(43) Pub. Date: Oct. 10, 2024

(54) OPTICAL ELEMENT DRIVE MECHANISM

(71) Applicant: TDK TAIWAN CORP., Taoyuan City (TW)

(72) Inventors: Chao-Chang HU, Taoyuan City (TW); Sin-Jhong SONG, Taoyuan City (TW)

(21) Appl. No.: 18/628,015

(22) Filed: Apr. 5, 2024

Related U.S. Application Data
(60) Provisional application No. 63/457,894, filed on Apr. 7, 2023.

(51) Int. Cl. G02B 5/00

(52) U.S. Cl. CPC G02B 5/005

(57) ABSTRACT

An optical element drive mechanism is provided. The optical element drive mechanism includes a first optical element, an immovable part, a first movable part, and a first drive assembly. The first movable part is connected to the immovable part. The first movable part is movable relative to the immovable part. The first drive assembly drives the first movable part to move relative to the immovable part. The immovable part includes an immovable-part opening, and light enters the immovable-part opening through a main axis.

### CROSS REFERENCE TO RELATED APPLICATIONS

This Application claims the benefit of U.S. Provisional Application No. 63/457,894, filed on Apr. 7, 2023, the entirety of which is incorporated by reference herein.

### BACKGROUND OF THE INVENTION

### Field of the Invention

The present disclosure relates to an optical element drive mechanism. Specifically, the present disclosure relates to an optical element drive mechanism that is able to change the amount of light that passes through.

### Description of the Related Art

In order to produce high-quality images, many electronic devices are equipped with optical element drive mechanisms that can control the amount of light that passes through (these optical element drive mechanisms may be referred to as apertures). Current optical element drive mechanisms usually include a hole formed by multiple optical elements, and the size of the hole is changed by changing the positions of the multiple optical elements, thereby controlling the amount of light that passes through. However, the shape of the hole formed by the multiple optical elements may not be circular, resulting in uneven brightness of the generated images. In addition, it is difficult to control the changes in the positions of the multiple optical elements.

### BRIEF SUMMARY OF THE INVENTION

An optical element drive mechanism is provided. The optical element drive mechanism includes a first optical element, an immovable part, a first movable part, and a first drive assembly. The first movable part is connected to the immovable part. The first movable part is movable relative to the immovable part. The first drive assembly drives the first movable part to move relative to the immovable part. The immovable part includes an immovable-part opening, and light enters the immovable-part opening through a main axis.

In some embodiments, the first optical element includes a first body, a first opening, a first shielding portion, and a first penetrating portion. The first opening is formed on the first body. The area of the first opening is different from the area of the immovable-part opening. The first shielding portion is located on the first body and close to the first opening. The first penetrating portion is formed on the edge of the first body and close to the first opening. In some embodiments, the area of the first opening is less than the area of the immovable-part opening.

In some embodiments, the immovable part includes a connecting structure, the first optical element further includes a first connecting portion formed close to the edge of the first body and connected to the connecting structure of the first movable part. In some embodiments, the connecting structure of the immovable part is a protrusion, the first connecting portion of the first movable part is a hole, and the protrusion and the hole create a close fit.

In some embodiments, the optical element drive mechanism further includes a second optical element, a second movable part, and a second drive assembly. The second movable part is connected to the second optical element. The second movable part is movable relative to the immovable part. The second drive assembly drives the second movable part to move relative to the immovable part. The second optical element includes a second body, a second shielding portion, and a second penetrating portion. The second shielding portion is located on the second body. The second penetrating portion is formed on the edge of the second body.

In some embodiments, the area of the second shielding portion is substantially equal to or slightly greater than the area of the first penetrating portion. In some embodiments, when viewed along a direction that is perpendicular to the main axis, the first optical element and the second optical element are located at different heights.

In some embodiments, the first movable part is able to change between a first initial position, a first operation position, and a first shielding position, the second movable part is able to change between a second initial position, a second shielding position, and a second operation position, so the first optical element and the second optical element are able to change between an immovable-part-opening-fully-revealed state, a first-opening-fully-revealed state, and a first-shielding-portion-shielding state.

In some embodiments, the optical element drive mechanism further includes a control unit. The control unit includes a database that stores information about the first initial position, the first operation position, the first shielding position, the second initial position, the second shielding position, and the second operation position. After an instruction is received, the control unit outputs a first control signal and a second control signal according to the instruction and the database to control the first drive assembly and the second drive assembly, respectively.

In some embodiments, the first shielding position is located between the first initial position and the first operation position, and the first shielding position is not located at the center of the first initial position and the first operation position.

In some embodiments, under the circumstances where the first optical element and the second optical element are in the immovable-part-opening-fully-revealed state, when viewed along the main axis, the first optical element does not overlap the immovable-part opening, and the second optical element does not overlap the immovable-part opening.

In some embodiments, the immovable part includes a first position-limiting structure, the first optical element further includes a first slit, under the circumstances where the first optical element and the second optical element are in the immovable-part-opening-fully-revealed state, the first position-limiting structure of the immovable part is in contact with an edge of the first slit of the first optical element.

In some embodiments, under the circumstances where the first optical element and the second optical element are in the first-opening-fully-revealed state, when viewed along the main axis, the first opening is fully located in the immovable-part opening, and the immovable-part opening, the first penetrating portion, the second shielding portion at least partially overlap each other.

In some embodiments, under the circumstances where the first optical element and the second optical element are in the first-shielding-portion-shielding state, when viewed along the main axis, the immovable-part opening, the first shielding portion, and the second penetrating portion at least partially overlap each other.

In some embodiments, the second optical element further includes a second opening formed on the second body, the second opening has an area, the area of the second opening is different from the area of the immovable-part opening. Under the circumstances where the first optical element and the second optical element are in the first-shielding-portion-shielding state, the second opening is fully located in the immovable-part opening.

In some embodiments, the immovable-part opening, the first opening, and the second opening are substantially circular. In some embodiments, the area of the second opening is different from the area of the first opening. In some embodiments, the first optical element further includes a first avoiding portion avoiding shielding the second opening of the second optical element, and the second optical element further includes a second avoiding portion avoiding shielding the first opening of the first optical element. In some embodiments, the curvature radius of the first avoiding portion is different from the curvature radius of the second avoiding portion.

### BRIEF DESCRIPTION OF THE DRAWINGS

The present disclosure can be more fully understood by reading the detailed description and examples with references made to the accompanying drawings. It should be noted that various features may be not drawn to scale. In fact, the dimensions of the various features may be arbitrarily increased or decreased for clarity of discussion, and the various features may be drawn schematically.

FIG. 1 is a perspective view of the optical element drive mechanism, in accordance with some embodiments.

FIG. 2 is an exploded view of the optical element drive mechanism, in accordance with some embodiments.

FIG. 3 is a cross-section view of the optical element drive mechanism taken along the sectional line AA of FIG. 1, in accordance with some embodiments.

FIG. 4 is a bottom view of the casing, the first movable part, and the second movable part, in accordance with some embodiments.

FIGS. 5A and 5B are schematic views under the circumstances where the first optical element and the second optical element are in the immovable-part-opening-fully-revealed state from opposite perspectives, in accordance with some embodiments, in which the base is omitted in FIG. 5A.

FIGS. 6A and 6B are schematic views under the circumstances where the first optical element and the second optical element are in the first-opening-fully-revealed state from opposite perspectives, in accordance with some embodiments, in which the base is omitted in FIG. 6A.

FIG. 6C is a schematic view in which the second optical element is omitted compared with FIG. 6B.

FIGS. 7A and 7B are schematic views under the circumstances where the first optical element and the second optical element are in the first-shielding-portion-shielding state from opposite perspectives, in accordance with some embodiments, in which the base is omitted in FIG. 7A.

FIG. 7C is a schematic view in which the first optical element is omitted compared with FIG. 7B.

### DETAILED DESCRIPTION OF THE INVENTION

The following description provides different embodiments, or examples, for implementing different features of the present disclosure. For example, the formation of a first feature “on” or “over” a second feature in the following description may include embodiments in which the first and second features are formed in direct contact, and may also include embodiments in which additional features may be formed between the first feature and the second feature, such that the first feature and the second feature are not in direct contact.

In addition, spatially relative terms may be used in the following description to describe the arrangements of various features. These spatially relative terms are for ease of describing the positional relationship between one feature and another feature as illustrated in the drawings. These spatially relative terms are intended to encompass different orientations of the device in use or operation in addition to the orientation illustrated in the drawings. The device may be otherwise oriented (rotated 90 degrees or at other orientations), and the spatially relative terms used in the following description may likewise be interpreted accordingly. For example, if a device of the drawings is flipped upside down, a feature that is “above” will become a feature that is “below”.

In the following description, the terms “including”, “comprising”, “having”, and the like should be interpreted as meaning “including but not limited to . . . ”. Therefore, when the terms “including”, “comprising”, “having”, and the like are used, the presence of corresponding features, regions, steps, operations and/or elements is specified, and without excluding the presence of other features, regions, steps, operations and/or elements.

Ordinal terms such as “first”, “second”, etc., used in the description and claims do not by themselves connote any priority, precedence, or order of one feature over another, but are used merely as labels to distinguish one feature from another feature having the same name. Therefore, a first feature in the description may be referred to as a second feature in claims. In addition, the following description may repeat reference numerals and/or letters in the various examples. This repetition is for the purpose of simplicity and clarity, and the repetition does not in itself dictate a relationship between the various embodiments and/or configurations discussed.

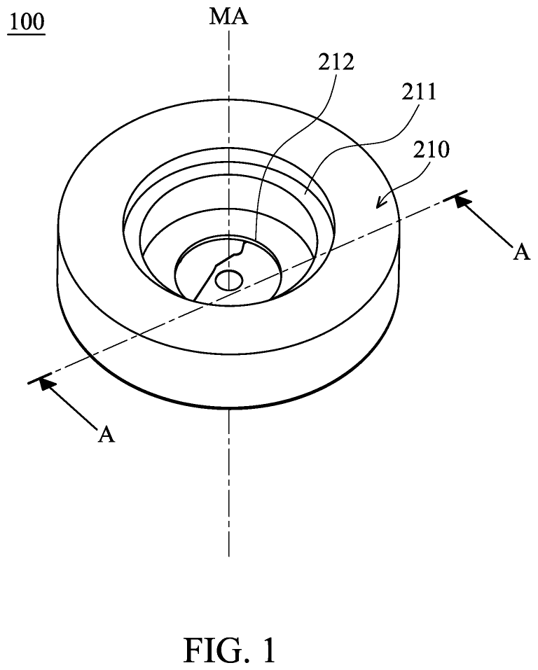

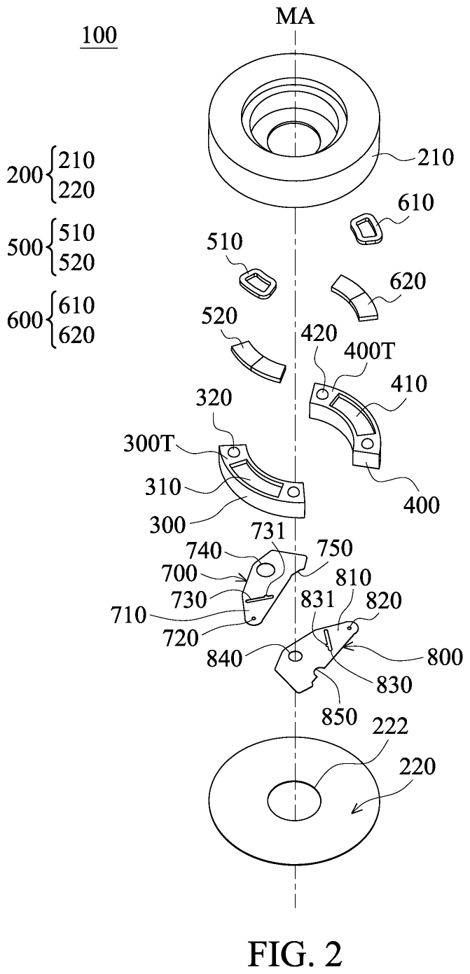

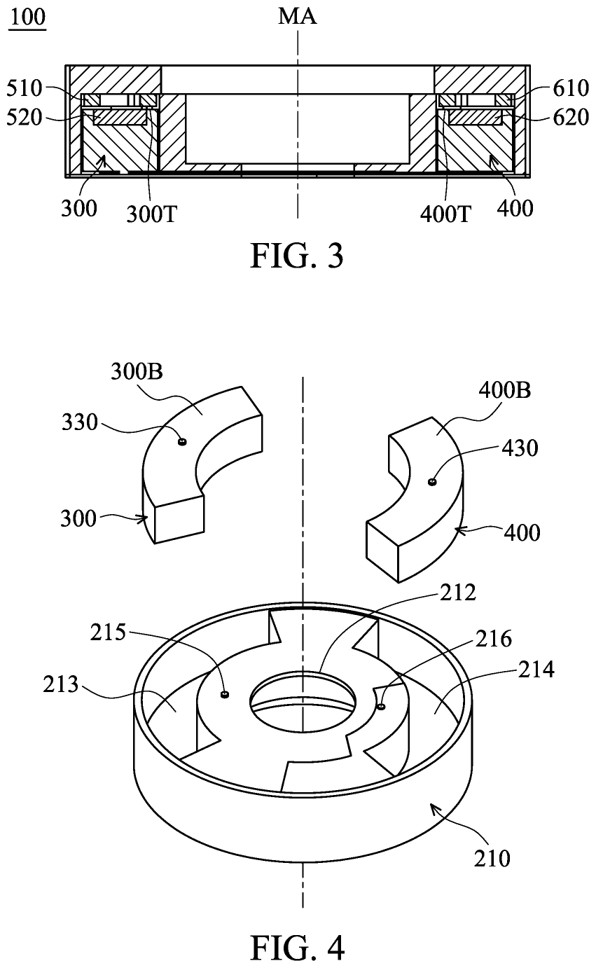

Please refer to FIG. 1 to FIG. 3 to understand an optical element drive mechanism 100. FIG. 1 is a perspective view of the optical element drive mechanism 100, in accordance with some embodiments. FIG. 2 is an exploded view of the optical element drive mechanism 100, in accordance with some embodiments. FIG. 3 is a cross-section view of the optical element drive mechanism 100 taken along the sectional line AA of FIG. 1, in accordance with some embodiments. For ease of illustration, the main axis MA is defined as the axis passing through the center of the optical element drive mechanism.

The optical element drive mechanism 100 includes an immovable part 200, a first movable part 300, a second movable part 400, a first drive assembly 500, a second drive assembly 600, a first optical element 700, and a second optical element 800. However, the elements included in the optical element drive mechanism 100 can be added or deleted according to the actual needs.

In some embodiments, the immovable part 200 includes a casing 210 and a base 220 arranged along the main axis MA. The casing 210 is connected to the base 220. The space between the casing 210 and the base 220 can accommodate the first movable part 300, the second movable part 400, the first drive assembly 500, the second drive assembly 600, the first optical element 700, and the second optical element 800.

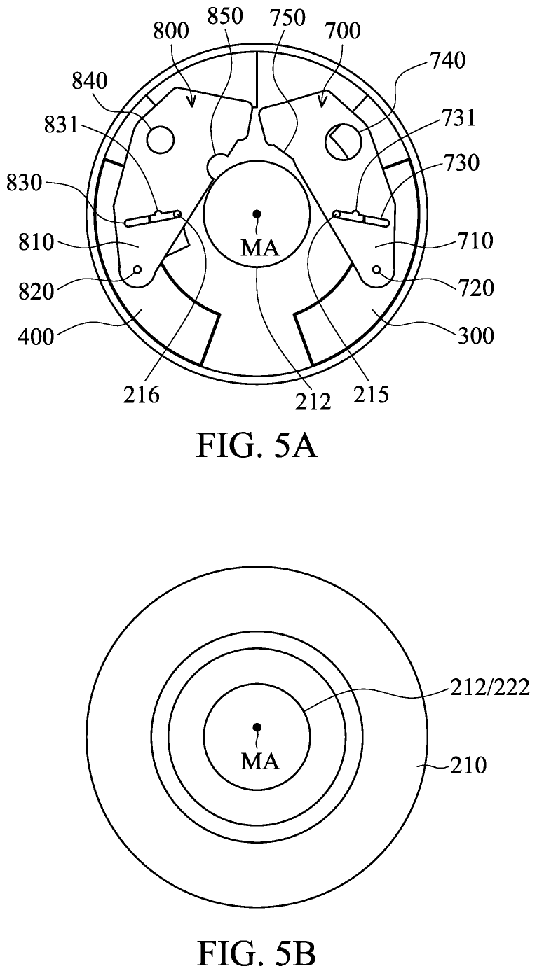

Next, in addition to FIG. 1 to FIG. 3, please refer to FIG. 4 to understand the casing 210, the first movable part 300, and the second movable part 400. FIG. 4 is a bottom view of the casing 210, the first movable part 300, and the second movable part 400, in accordance with some embodiments.

The casing 210 includes a top opening 211, a bottom opening 212, a first receiving portion 213, a second receiving portion 214, a first position-limiting structure 215, and a second position-limiting structure 216. Light can pass through the top opening 211 and the bottom opening 212 sequentially along the main axis MA. That is, light may enter the bottom opening 212. In some embodiments, the area of the top opening 211 is different from the area of the bottom opening 212. In some embodiments, the area of bottom opening 212 is less than the area of top opening 211. In some embodiments, the bottom opening 212 may be defined as an immovable-part opening.

The first receiving portion 213 is used to accommodate the first movable part 300 and the first drive assembly 500. In some embodiments, the first receiving portion 213 is the movement range of the first movable part 300. The second receiving portion 214 is used to receive the second movable part 400 and the second drive assembly 600. In some embodiments, the second receiving portion 214 is the movement range of the second movable part 400. In some embodiments, the first receiving portion 213 and the second receiving portion 214 are formed symmetrically, but the configuration of the first receiving portion 213 and the second receiving portion 214 is not limited thereto.

The first position-limiting structure 215 is close to the first receiving portion 213. In some embodiments, the first position-limiting structure 215 is a protrusion. The second position-limiting structure 216 is close to the second receiving portion 214. In some embodiments, the second position-limiting structure 216 is a protrusion. In some embodiments, the first position-limiting structure 215 and the second position-limiting structure 216 are arranged symmetrically, but the configuration of the first position-limiting structure 215 and the second position-limiting structure 216 is not limited thereto.

The base 220 includes a base opening 222. Light can enter the base opening 222. In some embodiments, the area of the base opening 222 is substantially the same as the area of the bottom opening 212 of the casing 210. In some embodiments, the base opening 222 may be defined as an immovable-part opening. In some embodiments, the one with the least area among the base opening 222, the top opening 211 of the casing 210, and the bottom opening 212 of the casing 210 may be defined as an immovable-part opening.

The first movable part 300 includes a top surface 300T, a bottom surface 300B, a first groove 310, two first guide structures 320, and a first connecting structure 330. The top surface 300T faces the casing 210. The bottom surface 300B faces the base 220. The first groove 310 is recessed relative to the top surface 300T. The first groove 310 may receive at least part of the first drive assembly 500. The first guide structures 320 protrude relative to the top surface 300T. The first guide structures 320 can make the movement of the first movable part 300 in the first receiving portion 213 smoother. In some embodiments, each of the first guide structures 320 has a smooth surface. The first connecting structure 330 protrudes relative to the bottom surface 300B. The first connecting structure 330 is connected to the first optical element 700. In some embodiments, the first connecting structure 330 is a protrusion.

Similarly, the second movable part 400 includes a top surface 400T, a bottom surface 400B, a second groove 410, two second guide structures 420, and a second connecting structure 430. The top surface 400T faces the casing 210. The bottom surface 400B faces the base 220. The second groove 410 is recessed relative to the top surface 400T. The second groove 410 may receive at least part of the second drive assembly 600. The second guide structures 420 protrude relative to the top surface 400T. The second guide structures 420 can make the movement of the second movable part 400 in the second receiving portion 214 smoother. In some embodiments, each of the second guide structures 420 has a smooth surface. The second connecting structure 430 protrudes relative to the bottom surface 400B. The second connecting structure 430 is connected to the second optical element 800. In some embodiments, the second connecting structure 430 is a protrusion.

Please refer to FIG. 2 and FIG. 3 to understand the first drive assembly 500 and the second drive assembly 600. The first drive assembly 500 includes a first coil 510 and a first magnetic element 520. Similarly, the second drive assembly 600 includes a second coil 610 and a second magnetic element 620. The shape and size of the first coil 510 are substantially the same as the shape and size of the second coil 610. The shape and size of the first magnetic element 520 are substantially the same as the shape and size of the second magnetic element 620.

The first coil 510 is disposed in the first receiving portion 213 of the casing 210. As shown in FIG. 3, the bottom surface of the first coil 510 is higher than the top surface 300T of the first movable part 300, so the first movable part 300 is able to move smoothly.

The first magnetic element 520 is disposed in the first groove 310 of the first movable part 300. In some embodiments, the shape of the first magnetic element 520 is substantially the same as the shape of the first groove 310 of the first movable part 300. In some embodiments, the size of the outer side of the first magnetic element 520 is greater than the size of the inner side of the first magnetic element 520 when viewed along the main axis MA. The first coil 510 and the first magnetic element 520 can generate magnetic force to drive the first movable part 300 to move relative to the immovable part 200. That is, the first drive assembly 500 is used to drive the first movable part 300 to move relative to the immovable part 200. In some embodiments, the first movable part 300 can rotate clockwise and counterclockwise relative to the immovable part 200.

The second coil 610 is disposed in the second receiving portion 214 of the casing 210. As shown in FIG. 3, the bottom surface of the second coil 610 is higher than the top surface 400T of the second movable part 400, so the second movable part 400 is able to move smoothly.

The second magnetic element 620 is disposed in the second groove 410 of the second movable part 400. In some embodiments, the shape of the second magnetic element 620 is substantially the same as the shape of the second groove 410 of the second movable part 400. In some embodiments, the size of the outer side of the second magnetic element 620 is greater than the size of the inner side of the second magnetic element 620 when viewed along the main axis MA. The second coil 610 and the second magnetic element 620 can generate magnetic force to drive the second movable part 400 to move relative to the immovable part 200. That is, the second drive assembly 600 is used to drive the second movable part 400 to move relative to the immovable part 200. In some embodiments, the second movable part 400 can rotate clockwise and counterclockwise relative to the immovable part 200.

It should be that in the embodiments illustrated in FIG. 2 and FIG. 3, the first coil 510 and the second coil 610 are provided on the immovable part 200, the first magnetic element 520 is provided on the first movable part 300, and the second magnetic element 620 is provided on the second movable part 400. Under such circumstances, when the first movable part 300 and the second movable part 400 move relative to the immovable part 200, the first magnetic element 520 provided on the first movable part 300 and the second magnetic element 620 provided on the second movable part 400 also move, and the optical element drive mechanism 100 may be referred to as a type of moving magnet.

However, the positions of the first coil 510 and the first magnetic element 520 can be exchanged, and the positions of the second coil 610 and the second magnetic element 620 can be exchanged, so the first coil 510 is provided on the first movable part 300 and the second coil 610 is provided on the second movable part 400. Under such circumstances, when the first movable part 300 and the second movable part 400 move relative to the immovable part 200, the first coil 510 provided on the first movable part 300 and the second coil 610 provided on the second movable part 400 also move, and the optical element drive mechanism 100 may be referred to as a type of moving coil.

In addition, since the first drive assembly 500 and the second drive assembly 600 drive the first movable part 300 and the second movable part 400 respectively, the first movable part 300 and the second movable part 400 can move independently. Therefore, the first movable part 300 and the second movable part 400 can be accurately controlled.

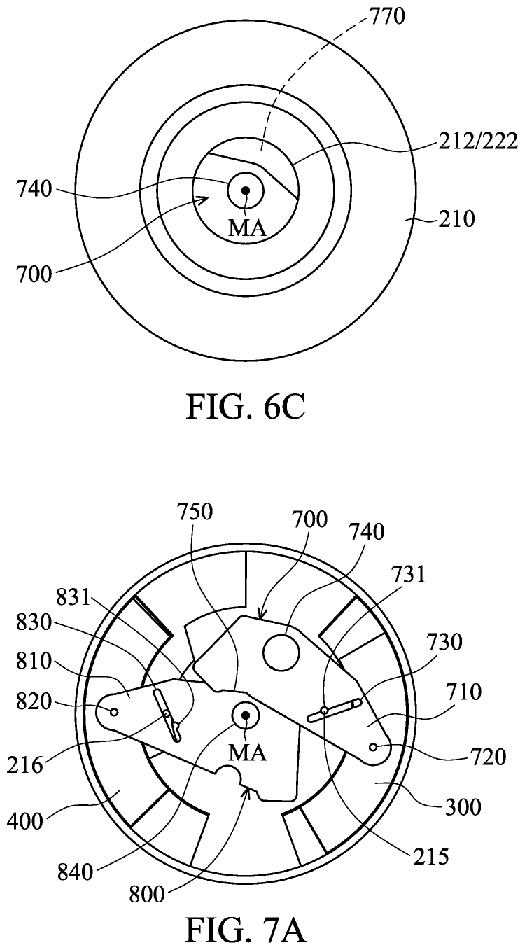

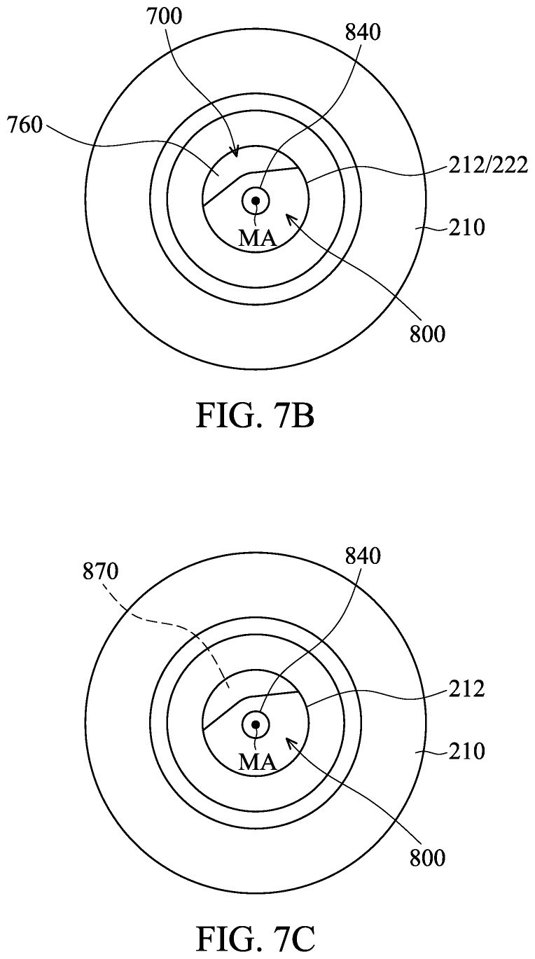

Next, please refer to FIG. 2 to understand the first optical element 700 and the second optical element 800. The first optical element 700 is disposed between the first movable part 300 and the base 220. The first optical element 700 includes a first body 710, a first connecting portion 720, a first slit 730, a first opening 740, a first avoiding portion 750, a first shielding portion 760 (denoted in FIG. 7B), and a first penetrating portion 770 (denoted in FIG. 6C). The second optical element 800 is disposed between the second movable part 400 and the base 220. Similarly, the second optical element 800 includes a second body 810, a second connecting portion 820, a second slit 830, a second opening 840, a second avoiding portion 850, a second shielding portion 860 (denoted in FIG. 6B), and a second penetrating portion 870 (denoted in FIG. 7C).

The first body 710 may have an irregular shape. The size and shape of the first body 710 may be accordingly designed according to the size of the casing 210, the size of the base opening 222, and the movement range of the first movable part 300. In some embodiments, the first body 710 is made of SOMA light-shielding material. The first connecting portion 720 is formed close to the edge of the first body 710. In some embodiments, the first connecting portion 720 is a hole. The first connecting portion 720 is connected to the first connecting structure 330 of the first movable part 300. In some embodiments, the first connecting portion 720 and the first connecting structure 330 of the first movable part 300 can achieve a close fit. Through the connection between the first connecting portion 720 and the first movable part 300, the first movable part 300 can drive the first optical element 700 to move more smoothly.

The first slit 730 is formed between the first connecting portion 720 and the first opening 740. The first slit 730 can be engaged with the first position-limiting structure 215 of the immovable part 200 to achieve position-limiting. In some embodiments, the first slit 730 includes a recessed portion 731. The first opening 740 is formed on the first body 710. In some embodiments, the area of the first opening 740 is different from the area of the immovable-part opening (which may be the bottom opening 212 of the casing 210 or the base opening 222 of the base 220). For example, the area of the first opening 740 is less than the area of the immovable-part opening. The first avoiding portion 750 is formed on the edge of the first body 710. When the first optical element 700 and the second optical element 800 partially overlap (for example, under the circumstances where the first optical element 700 and the second optical element 800 are in the first-shielding-portion-shielding state, which will be described with respect to FIG. 7A to FIG. 7C), the first avoiding portion 750 is used to avoid the second opening 840 to prevent the first optical element 700 from shielding the second opening 840.

The first shielding portion 760 is located on the first body 710, and the first shielding portion 760 is close to the first opening 740. The first shielding portion 760 is used to assist in shielding the immovable-part opening to avoid stray light. The first penetrating portion 770 is formed on the edge of the first body 710, and the first penetrating portion 770 is close to the first opening 740. The first penetrating portion 770 is a part through which light can pass. In some embodiments, the first penetrating portion 770 is an open recess.

The second body 810 may have an irregular shape. The size and shape of the second body 810 may be accordingly designed according to the size of the casing 210, the size of the base opening 222, and the movement range of the second movable part 400. In some embodiments, the second body 810 is made of SOMA light-shielding material. The second connecting portion 820 is formed close to the edge of the second body 810. In some embodiments, the second connecting portion 820 is a hole. The second connecting portion 820 is connected to the second connecting structure 430 of the second movable part 400. In some embodiments, the second connecting portion 820 and the second connecting structure 430 of the second movable part 400 can achieve a close fit. Through the connection between the second connecting portion 820 and the second movable part 400, the second movable part 400 can drive the second optical element 800 to move more smoothly.

The second slit 830 is formed between the second connecting portion 820 and the second opening 840. The second slit 830 can be engaged with the second position-limiting structure 216 of the immovable part 200 to achieve position-limiting. In some embodiments, the second slit 830 includes a recessed portion 831. The second opening 840 is formed on the second body 810. In some embodiments, the area of the second opening 840 is different from the area of the immovable-part opening. For example, the area of the second opening 840 is less than the area of the immovable-part opening. In some embodiments, the area of the second opening 840 is different from the area of the first opening 740. For example, the area of the second opening 840 is less than the area of the first opening 740.

The second avoiding portion 850 is formed on the edge of the second body 810. When the first optical element 700 and the second optical element 800 partially overlap (for example, under the circumstances where the first optical element 700 and the second optical element 800 are in the first-opening-fully-revealed state, which will be described with respect to FIG. 6A to FIG. 6C), the second avoiding portion 850 is used to avoid the first opening 740 to prevent the second optical element 800 from shielding the first opening 740.

In some embodiments, since the area of the second opening 840 is different from the area of the first opening 740, the curvature radius of the second avoiding portion 850 that has to avoid the first opening 740 is different from the curvature radius of the first avoiding portion 750 that has to avoid the second opening 840. In some embodiments, the curvature radius of the second avoiding portion 850 may be less than the curvature radius of the first avoiding portion 750, but the relationship between the curvature radii is not limited thereto.

The second shielding portion 860 is located on the second body 810, and the second shielding portion 860 is close to the second opening 840. The second shielding portion 860 is used to assist in shielding the immovable-part opening to avoid stray light. The second penetrating portion 870 is formed on the edge of the second body 810, and the second penetrating portion 870 is close to the second opening 840. The second penetrating portion 870 is a part through which light can pass. In some embodiments, the second penetrating portion 870 is an open recess.

The first movable part 300 is connected to the first optical element 700, the first movable part 300 can be driven by the first drive assembly 500, so the first movable part 300 and the first optical element 700 connected thereto can move relative to the immovable part 200, thereby changing the extent to which the first optical element 700 shields the immovable-part opening. Similarly, the second movable part 400 is connected to the second optical element 800, the second movable part 400 can be driven by the second drive assembly 600, so the second movable part 400 and the second optical element 800 connected thereto can move relative to the immovable part 200, thereby changing the extent to which the second optical element 800 shields the immovable-part opening.

As described above, through the movement of the first movable part 300 and the movement of the second movable part 400, the extent to which the first optical element 700 shields the immovable-part opening and the extent to which the second optical element 800 shields the immovable-part opening can be changed. Therefore, the amount of light passing through the optical element drive mechanism 100 can be changed. Specifically, the first movable part 300 is able to change between a first initial position, a first operation position, and a first shielding position, the second movable part 400 is able to change between a second initial position, a second shielding position, and a second operation position, so the first optical element 700 and the second optical element 800 are able to change between the immovable-part-opening-fully-revealed state, the first-opening-fully-revealed state, and the first-shielding-portion-shielding state.

The first shielding position is located between the first initial position and the first operation position. In some embodiments, the first shielding position is not located at the center of the first initial position and the first operation position. For example, there may be an included angle of ten degrees between the first initial position and the first operation position, and the first shielding position would not be located at a position that has an included angle of five degrees from the first initial position. The second shielding position is located between the second initial position and the second operation position. In some embodiments, the second shielding position is not located at the center of the second initial position and the second operation position. For example, there may be a distance between the second initial position and the second operation position, but the second shielding position would not be located at half this distance from the first initial position.

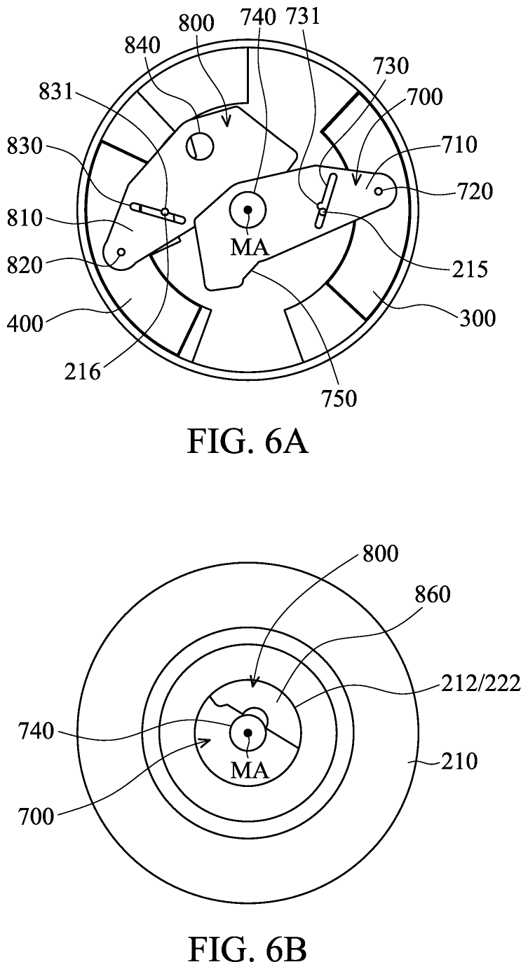

Next, how the movement of the first movable part 300 and the movement of the second movable part 400 changes the state of the first optical element 700 and the second optical element 800 will be described with respect to FIG. 5A, FIG. 5B, FIG. 6A, FIG. 6B, FIG. 6C, FIG. 7A, FIG. 7B, and FIG. 7C. FIGS. 5A and 5B are schematic views under the circumstances where the first optical element 700 and the second optical element 800 are in the immovable-part-opening-fully-revealed state from opposite perspectives, in accordance with some embodiments, in which the base 220 is omitted in FIG. 5A. FIGS. 6A and 6B are schematic views under the circumstances where the first optical element 700 and the second optical element 800 are in the first-opening-fully-revealed state from opposite perspectives, in accordance with some embodiments, in which the base 220 is omitted in FIG. 6A. FIG. 6C is a schematic view in which the second optical element 800 is omitted compared with FIG. 6B. FIGS. 7A and 7B are schematic views under the circumstances where the first optical element 700 and the second optical element 800 are in the first-shielding-portion-shielding state from opposite perspectives, in accordance with some embodiments, in which the base 220 is omitted in FIG. 7A. FIG. 7C is a schematic view in which the first optical element 700 is omitted compared with FIG. 7B.

As shown in FIG. 5A and FIG. 5B, the first movable part 300 is in the first initial position, the second movable part 400 is in the second initial position, and the first optical element 700 and the second optical element 800 are in the immovable-part-opening-fully-revealed state. Under the circumstances where the first optical element 700 and the second optical element 800 are in the immovable-part-opening-fully-revealed state, when viewed along the main axis MA, the first optical element 700 does not overlap the immovable-part opening, and the second optical element 800 does not overlap the immovable-part opening, either. Therefore, the immovable-part opening is not shielded by the first optical element 700 and the second optical element 800, and the immovable-part opening is fully revealed.

In some embodiments, under the circumstances where the first optical element 700 and the second optical element 800 are in the immovable-part-opening-fully-revealed state, the first position-limiting structure 215 of the casing 210 may be in contact with the edge of the first slit 730 of the first optical element 700, and the second position-limiting structure 216 of the casing 210 may be in contact with the edge of the second slit 830 of the second optical element 800.

In addition, for the entire optical element drive mechanism 100, under the circumstances where the first optical element 700 and the second optical element 800 are in the immovable-part-opening-fully-revealed state, the amount of light passing through depends on the area of the immovable-part opening. In some embodiments, the immovable-part opening is substantially circular. Therefore, under the circumstances where the first optical element 700 and the second optical element 800 are in the immovable-part-opening-fully-revealed state, light can uniformly pass through the circular immovable-part opening to achieve better optical properties.

In the embodiments illustrated in FIG. 6A to FIG. 6C, the first movable part 300 is in the first operation position, the second movable part 400 is in the second shielding position, and the first optical element 700 and the second optical element 800 are in the first-opening-fully-revealed state. Please refer to FIG. 6B and FIG. 6C. Under the circumstances where the first optical element 700 and the second optical element 800 are in the first-opening-fully-revealed state, the first penetrating portion 770 is the part that the first optical element 700 cannot shield the immovable-part opening, and the second shielding portion 860 can shield the first penetrating portion 770, preventing light from passing through the first penetrating portion 770. That is, under the circumstances where the first optical element 700 and the second optical element 800 are in the first-opening-fully-revealed state, the immovable-part opening, the first penetrating portion 770, and the second shielding portion 860 at least partially overlap. In some embodiments, the area of the second shielding portion 860 is substantially equal to or slightly greater than the area of the first penetrating portion 770.

In some embodiments, under the circumstances where the first optical element 700 and the second optical element 800 are in the first-opening-fully-revealed state, when viewed along the main axis MA, the first opening 740 is fully located in the immovable-part opening. In some embodiments, the first-opening-fully-revealed state represents that the center of the first opening 740 completely coincides with the center of the immovable-part opening.

In some embodiments, the first opening 740 is substantially circular. Therefore, under the circumstances where the first optical element 700 and the second optical element 800 are in the first-opening-fully-revealed state, light can uniformly pass through the circular first opening 740, so the generated images have better optical properties. If the second optical element 800 is omitted, the light would pass through the first opening 740 and the first penetrating portion 770, which may cause the generated images to have uneven brightness.

In some embodiments, under the circumstances where the first optical element 700 and the second optical element 800 are in the first-opening-fully-revealed state, the second position-limiting structure 216 of the casing 210 may be located in the recessed portion 831 of the second slit 830 of the second optical element 800 to ensure the second optical element 800 is located at a desired position.

In the embodiments illustrated in FIG. 7A to FIG. 7C, the first movable part 300 is in the first shielding position, the second movable part 400 is in the second operation position, and the first optical element 700 and the second optical element 800 are in the first-shielding-portion-shielding state. Please refer to FIG. 7B and FIG. 7C. Under the circumstances where the first optical element 700 and the second optical element 800 are in the first-shielding-portion-shielding state, the second penetrating portion 870 is the part that the second optical element 800 cannot shield the immovable-part opening, and the first shielding portion 760 can shield the second penetrating portion 870, preventing light from passing through the second penetrating portion 870. That is, under the circumstances where the first optical element 700 and the second optical element 800 are in the first-shielding-portion-shielding state, the immovable-part opening, the first shielding portion 760 and the second penetrating portion 870 at least partially overlap.

In some embodiments, under the circumstances where the first optical element 700 and the second optical element 800 are in the first-shielding-portion-shielding state, when viewed along the main axis MA, the second opening 840 is completely located in the immovable-part opening. In this way, the first-shielding-portion-shielding state may also be regarded as the second-opening-fully-revealed state. In some embodiments, the first-shielding-portion-shielding state or the second-opening-fully-revealed state represents that the center of the second opening 840 completely coincides with the center of the immovable-part opening.

In some embodiments, the second opening 840 is substantially circular. Therefore, under the circumstances where the first optical element 700 and the second optical element 800 are in the first-shielding-portion-shielding state, light can uniformly pass through the circular second opening 840, so the generated images have better optical properties. If the first optical element 700 is omitted, light would pass through the second opening 840 and the second penetrating portion 870, which may cause the generated images to have uneven brightness. In addition, since the area of the second opening 840 is different from the area of the first opening 740, which of the first opening 740 and the second opening 840 is revealed can be determined according to the actual needs (for example, the desired amount of light that passes through).

In some embodiments, under the circumstances where the first optical element 700 and the second optical element 800 are in the first-shielding-portion-shielding state, the first position-limiting structure 215 of the casing 210 may be located in the recessed portion 731 of the first slit 730 of the first optical element 700 to ensure the first optical element 700 is located at a desired position.

In some embodiments, the second optical element 800 may not have the second opening 840. Under the circumstances where the first optical element 700 and the second optical element 800 are in the first-shielding-portion-shielding state, when viewed along the main axis MA, the first optical element 700 and the second optical element 800 completely shield the immovable-part opening, so light cannot pass through the immovable-part opening. In this way, the optical element drive mechanism 100 may have a fully open aperture (that is, the immovable-part opening is not shielded) and a fully closed aperture (that is, the immovable-part opening is completely shielded by the first optical element 700 and the second optical element 800), and the optical element drive mechanism 100 may be regarded as a shutter mechanism.

In short, since the first optical element 700 and the second optical element 800 shield the immovable-part opening collaboratively, the sizes of the first optical element 700 and the second optical element 800 can be reduced to achieve miniaturization of the first optical element 700 and the second optical element 800, thereby achieving miniaturization and weight reduction of the entire optical element drive mechanism 100. If a single optical element needs to cover the entire immovable-part opening, it may be larger in size and heavier in weight.

In some embodiments, no matter the first optical element 700 and the second optical element 800 are in the first-opening-fully-revealed state or the first-shielding-portion-shielding state, the first optical element 700 is located below the second optical element 800. That is, the first optical element 700 is closer to the base 220 than the second optical element 800. That is, when viewed along a direction that is perpendicular to the main axis MA, the first optical element 700 and the second optical element 800 are located at different heights. Since the first optical element 700 is located below the second optical element 800, the difference between FIG. 7C (in which the first optical element 700 is omitted) and FIG. 7B can be hardly seen.

In some embodiments, the optical element drive mechanism 100 further includes a sensing unit (not shown) and a control unit (not shown). The sensing unit may include a Hall sensor, a Giant Magneto Resistance (GMR) sensor, a Tunneling Magneto Resistance (TMR) sensor, etc. The sensing unit can sense changes in density and/or directions of lines of magnetic field of the first magnetic element 520 and the second magnetic element 620 to obtain the position of the first movable part 300 and the position of the second movable part 400. The sensing unit can be used to define the control signal that is output to the control unit.

In some embodiments, the control unit is a driver IC. The control unit includes a database that stores information about the first initial position, the first operation position, the first shielding position, the second initial position, the second shielding position, and the second operation position. After an instruction is received, the control unit outputs a first control signal and a second control signal according to the instruction and the database to control the first drive assembly 500 and the second drive assembly 600, respectively. For example, when the instruction is to require the first optical element 700 and the second optical element 800 to change to the first-opening-fully-revealed state, the first control signal makes the first movable part 300 move to the first operation position, and the second control signal makes the second movable part 400 move to the second shielding position.

In some embodiments, the optical element drive mechanism 100 can be disposed on a lens device to change the amount of light passing through the lens device.

An optical element drive mechanism is provided. The optical element drive mechanism includes an immovable part, a first movable part, a second movable part, a first drive assembly, a second drive assembly, a first optical element, and a second optical element. The immovable part includes an immovable-part opening. The first optical element includes a first opening less than the immovable-part opening.

The first movable part is connected to the first optical element, the first movable part can be driven by the first drive assembly, so the first movable part and the first optical element connected thereto can move relative to the immovable part, thereby changing the extent to which the first optical element shields the immovable-part opening. Similarly, the second movable part is connected to the second optical element, the second movable part can be driven by the second drive assembly, so the second movable part and the second optical element connected thereto can move relative to the immovable part, thereby changing the extent to which the second optical element shields the immovable-part opening.

Specifically, the first movable part is able to change between a first initial position, a first operation position, and a first shielding position, the second movable part is able to change between a second initial position, a second shielding position, and a second operation position, so the first optical element and the second optical element are able to change between the immovable-part-opening-fully-revealed state, the first-opening-fully-revealed state, and the first-shielding-portion-shielding state.

In addition, the first optical element may include a first shielding portion to assist in shielding the immovable-part opening, a first penetrating portion to reduce the size of the first optical element, etc. In embodiments where the second optical element includes a second opening, the first optical element may further include a first avoiding portion to avoid shielding the second opening of the second optical element.

Since whatever the state is, light can uniformly passes through a substantially circular opening (such as the immovable-part opening described above (which may be the bottom opening 212 of the casing 210 or the base opening 222 of the base 220), the first opening 740, and the second opening 840) to ensure that the generated images have uniform brightness. In addition, by controlling the first movable part and the second movable part respectively through the first drive assembly and the second drive assembly, the states of the first optical element and the second optical element can be accurately controlled. In addition, since the first optical element and the second optical element shield the immovable-part opening collaboratively, the sizes of the first optical element and the second optical element can be reduced to achieve miniaturization of the first optical element and the second optical element, thereby achieving miniaturization and weight reduction of the entire optical element drive mechanism. In addition, since multiple optical elements are not required, the manufacturing process can be simplified and manufacturing costs can be reduced.

The foregoing outlines features of several embodiments, so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced in the following description. Those skilled in the art should also realize that such equivalent constructions do not depart from the spirit and scope of the present disclosure, and that they may make various changes, substitutions, and alterations in the following description without departing from the spirit and scope of the present disclosure.

What is claimed is:

1. An optical element drive mechanism, comprising:
a first optical element;
an immovable part;
a first movable part connected to the immovable part, wherein the first movable part is movable relative to the immovable part; and
a first drive assembly driving the first movable part to move relative to the immovable part;
wherein the immovable part comprises an immovable-part opening, and light enters the immovable-part opening through a main axis.

2. The optical element drive mechanism as claimed in claim 1, wherein the first optical element comprises:
a first body;
a first opening formed on the first body, wherein the first opening has an area, the immovable-part opening has an area, and the area of the first opening is different from the area of the immovable-part opening;
a first shielding portion located on the first body and close to the first opening; and
a first penetrating portion formed on an edge of the first body and close to the first opening.

3. The optical element drive mechanism as claimed in claim 2, wherein the area of the first opening is less than the area of the immovable-part opening.

4. The optical element drive mechanism as claimed in claim 2, wherein the immovable part comprises a connecting structure, the first optical element further comprises a first connecting portion formed close to the edge of the first body and connected to the connecting structure of the first movable part.

5. The optical element drive mechanism as claimed in claim 4, wherein the connecting structure of the immovable part is a protrusion, the first connecting portion of the first movable part is a hole, and the protrusion and the hole create a close fit.

6. The optical element drive mechanism as claimed in claim 2, further comprising:
a second optical element;
a second movable part connected to the second optical element, wherein the second movable part is movable relative to the immovable part; and
a second drive assembly driving the second movable part to move relative to the immovable part;
wherein the second optical element comprises:
a second body;
a second shielding portion located on the second body; and
a second penetrating portion formed on an edge of the second body.

7. The optical element drive mechanism as claimed in claim 6, wherein the second shielding portion has an area, the first penetrating portion has an area, and the area of the second shielding portion is substantially equal to or slightly greater than the area of the first penetrating portion.

8. The optical element drive mechanism as claimed in claim 6, wherein when viewed along a direction that is perpendicular to the main axis, the first optical element and the second optical element are located at different heights.

9. The optical element drive mechanism as claimed in claim 6, wherein the first movable part is able to change between a first initial position, a first operation position, and a first shielding position, the second movable part is able to change between a second initial position, a second shielding position, and a second operation position, so the first optical element and the second optical element are able to change between an immovable-part-opening-fully-revealed state, a first-opening-fully-revealed state, and a first-shielding-portion-shielding state.

10. The optical element drive mechanism as claimed in claim 9, further comprising a control unit, wherein the control unit comprises a database that stores information about the first initial position, the first operation position, the first shielding position, the second initial position, the second shielding position, and the second operation position, after an instruction is received, the control unit outputs a first control signal and a second control signal according to the instruction and the database to control the first drive assembly and the second drive assembly, respectively.

11. The optical element drive mechanism as claimed in claim 9, wherein the first shielding position is located between the first initial position and the first operation position, and the first shielding position is not located at a center of the first initial position and the first operation position.

12. The optical element drive mechanism as claimed in claim 9, wherein under the circumstances where the first optical element and the second optical element are in the immovable-part-opening-fully-revealed state, when viewed along the main axis, the first optical element does not overlap the immovable-part opening, and the second optical element does not overlap the immovable-part opening.

13. The optical element drive mechanism as claimed in claim 9, wherein the immovable part comprises a first position-limiting structure, the first optical element further comprises a first slit, under the circumstances where the first optical element and the second optical element are in the immovable-part-opening-fully-revealed state, the first position-limiting structure of the immovable part is in contact with an edge of the first slit of the first optical element.

14. The optical element drive mechanism as claimed in claim 9, wherein under the circumstances where the first optical element and the second optical element are in the first-opening-fully-revealed state, when viewed along the main axis, the first opening is fully located in the immovable-part opening, and the immovable-part opening, the first penetrating portion, the second shielding portion at least partially overlap each other.

15. The optical element drive mechanism as claimed in claim 9, wherein under the circumstances where the first optical element and the second optical element are in the first-shielding-portion-shielding state, when viewed along the main axis, the immovable-part opening, the first shielding portion, and the second penetrating portion at least partially overlap each other.

16. The optical element drive mechanism as claimed in claim 9, wherein the second optical element further comprises a second opening formed on the second body, the second opening has an area, the area of the second opening is different from the area of the immovable-part opening, wherein under the circumstances where the first optical element and the second optical element are in the first-shielding-portion-shielding state, the second opening is fully located in the immovable-part opening.

17. The optical element drive mechanism as claimed in claim 16, wherein the immovable-part opening, the first opening, and the second opening are substantially circular.

18. The optical element drive mechanism as claimed in claim 16, wherein the area of the second opening is different from the area of the first opening.

19. The optical element drive mechanism as claimed in claim 16, wherein the first optical element further comprises a first avoiding portion avoiding shielding the second opening of the second optical element, and the second optical element further comprises a second avoiding portion avoiding shielding the first opening of the first optical element.

20. The optical element drive mechanism as claimed in claim 19, wherein a curvature radius of the first avoiding portion is different from a curvature radius of the second avoiding portion.
